(19) United States
(12) Patent Application Publication
(10) Pub. No.: US 2014/0122621 A1
(43) Pub. Date: May 1, 2014

(54) METHODS AND SYSTEMS FOR ORGANIZING ELECTRONIC MESSAGES

(71) Applicant: Jedediah Michael Feller, Las Vegas, NV (US)

(72) Inventor: Jedediah Michael Feller, Las Vegas, NV (US)

(21) Appl. No.: 13/665,372

(22) Filed: Oct. 31, 2012

(51) Int. Cl. G06F 15/16

(52) U.S. Cl. 709/206

(57) ABSTRACT

Methods, systems, and apparatus for organizing electronic messages are provided. The method includes receiving a first electronic message having a first electronic object, determining, using a processor, an electronic object store based on the first electronic object, and storing the first electronic object in the electronic object store such that the first electronic message is associated with the first electronic object.

### BACKGROUND OF THE INVENTION

The present invention relates generally to an improved data processing system for organizing electronic messages. More particularly, the present invention relates to the organization of electronic messages by conversion to other types of media and altered relationships of those media.

Information and electronic communications are increasing in both volume and speed. For recipients of such electronic communications, the amount of information received is becoming increasingly difficult to manage. Often, the medium for transmitting the information is not an appropriate or efficient medium to store or organize the information. Furthermore, when information is transmitted, the information is often sent using the most readily available medium, which may not be the most appropriate or efficient medium. When the most appropriate or efficient medium is not available, it would be desirable to transmit information through an available medium with controls or processes that could convert to or generate the most appropriate medium at one of at least three points of transmission: 1) at the point of transmission, 2) during the transmission, or 3) at the point the transmission is received.

Electronic messages, such as electronic mail, have become the center of electronic communications and organization of information for many. As electronic mail programs have become more and more sophisticated, the electronic mail programs have become more tedious and difficult to use. Often, users have huge amounts of email messages sitting in “inboxes” because the users do not want to delete the messages and only have an option to move the messages to a folder or archive the messages. While the archiving and folder options may minimize a full inbox, as the message volume builds, these options become less efficient. It would be desirable to have a method or process that allows the messages to be deleted immediately if a task, calendar item, contact, video, or other appropriate electronic object is generated based upon the information in the message.

Often, certain types of electronic communications could be much more efficient if the electronic communication executed a predefined method, or process and then informed the recipient that the method or process was done, rather than requiring the recipient to download or execute several steps to receive the information. Conversely, if the electronic communication cannot execute the predefined method, process, or system before the recipient receives the information or automatically when the recipient receives the information, then it would be desirable to have the predefined method, process, or system executed through predefined user inputs, such as gestures, clicks or drag and drop functions.

### BRIEF DESCRIPTION OF THE INVENTION

In one embodiment, a computer-implemented method for processing electronic messages using a computer device coupled to a memory device is provided. The method includes receiving a first electronic message having a first electronic object, determining, using a processor, an electronic object store based on the first electronic object, and storing the first electronic object in the electronic object store such that the first electronic message is associated with the first electronic object.

### BRIEF DESCRIPTION OF THE DRAWINGS

FIGS. 1-3 show exemplary embodiments of the methods and systems described herein.

FIG. 1 is a diagram of an exemplary system for processing electronic messages.

FIG. 2 is a flowchart of an exemplary method for processing electronic messages.

FIG. 3 is a block diagram illustrating a representative computing device that may be used to implement the system of FIG. 1.

Like reference numbers and designations in the various drawings indicate like elements.

### DETAILED DESCRIPTION OF THE INVENTION

Embodiments of the methods and systems described herein enable an electronic message processing system to receive and organize electronic messages. Electronic messages may be received in a first format. Electronic messages may include emails, text messages, voicemails, faxes, social media messages, and the like. The electronic messages may include one or more electronic objects, such as an attachment. The electronic objects may include pictures, videos, audio files, documents, contacts, calendar items, to do items, etc. The electronic message processing system may translate the electronic message to a second format based on a user setting and/or the electronic object, and the first format may be associated with the second format. The translated electronic message may be organized and/or stored with other similar electronic messages. For example, an email may be received, in an inbox, that includes a picture attachment. The picture may be saved with other pictures, the email may be associated with the picture, and the email may be deleted from the inbox.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

The methods and systems described herein may be implemented using computer programming or engineering techniques including computer software, firmware, hardware or any combination or subset thereof, wherein the technical effects may include at least one of: a) receiving a first electronic message having a first electronic object; b) determining, using a processor, an electronic object store based on the first electronic object; and c) storing the first electronic object in the electronic object store such that the first electronic message is associated with the first electronic object.

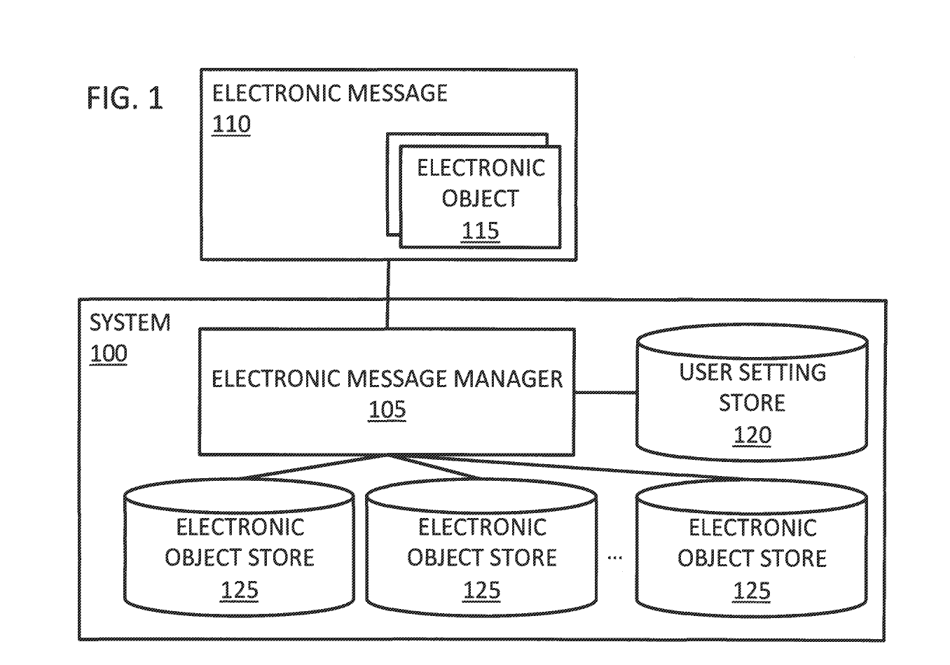

FIG. 1 is a diagram of an exemplary system 100 for processing electronic messages. System 100 includes an electronic message manager 105 that is configured to receive an electronic message 110. In the exemplary embodiment, the electronic message 110 includes an electronic object 115. The electronic message 110 may be in a first format, such as an email, text message, voicemail, social media message such as a tweet, or the like. The electronic message 110 may refer to, at least in part, an electronic envelope for use in delivering electronic objects 115. For example, the electronic message 110 may be an email and/or include headers or other data used to address or transmit electronic objects 115 to a recipient. In some cases, the electronic message 110 includes the electronic object 115 without more. The electronic object 115 may be a picture, video, audio file, document, text, contact, calendar item, to do item, or any combination thereof The electronic object 115 may be associated with the electronic message 110 as an attachment, via a uniform resource locator (URL), and/or as an inline resource. The electronic object 115 may be a recipient, a sender, a carbon copy, a blind carbon copy, a subject, a message body, or any part or combination thereof The electronic objects 115 may be heterogeneous and diverse.

The electronic message manager 105 may be configured to receive electronic messages 110 in one or more formats. A user settings store 120 includes user-provided settings that the electronic message manager 105 may use to determine how to process a message. For example, a user setting may indicate that electronic messages 110 that include calendar items should be deleted after the electronic message 110 is processed by the electronic message manager 105.

The system 100 may include one or more electronic object stores 125 for storing electronic objects 115. The electronic object stores 125 may be implemented as databases, file directories, or as object-specific stores such as calendars, contact lists, to-read lists, shopping lists, notes, and to-do or task lists. Electronic message manager 105 is configured to access the electronic object stores 125 and may add, manipulate, and/or delete objects within the electronic object stores 125.

During operation, the electronic message manager 105 receives the electronic message 110 having one or more electronic objects 115. The electronic message manager 105, automatically or at the direction of the user, determines, based on user settings in the user settings store 120 and the type of the electronic objects 115, which electronic object store(s) 125 into which to store the electronic object(s) 115.

For example, the electronic message manager 105 may convert an email with an attachment into a to-do item with an attachment. In this example, an employee receives the email from a supervisor requesting that the employee start on a project to revise an employee manual section. The email provides a specific day for the project to be completed, and the attachment is the employee manual in a portable document format. Known email program options allow the employee to leave the electronic message in an inbox or move the email to a folder or archive it. Known options also allow the employee to flag the email or prioritize the email. Ideally, the employee would put the email on a task list or in a task manager and assign the task the designated due date. In known email programs, several steps must be taken (typically manual entry) in order to put the email into a task list. The employee might cut and paste the appropriate parts of the email message, but the process still takes several steps and the message remains in the inbox after the process. In this example, the employee could convert the email to a task object by clicking on a task icon. In response to the click on the task icon, the electronic message manager 105 may execute one or more operations, such as: (a) generating a task object based on data included in the electronic message, such as the subject, body, etc., (b) attaching the attachment (i.e., the employee manual) to the task object, and (c) deleting the email from the inbox. If the employee did not need the attachment or the employee did not wish to maintain the email, one or both could be deleted. Generating the task object may include extracting the desired completion date from the message body in order to determine the due date of the task object.

In another example, a user receives an email that includes a hyperlink to a video. The user would like to view the video clip in the future, but does not want the message sitting in the email inbox. Known email programs allow the user to archive the message or move the message into a folder. Thus, in known email programs, when the user wants to view the video clip, the user would have to find the message in the folder or archive, open the message, download the video clip, and then view the video clip. In this example, the user could click on a video icon that may cause the electronic message manager 105 to execute one or more operations, such as: (a) downloading the video clip, (b) saving the video clip in a video folder for direct access and later viewing, (c) attaching or otherwise associating the email to the video clip, e.g., by copying the message body into a notes section of the video clip, and (d) deleting the message from the inbox. If the user did not wish to maintain the message, the message could be deleted. The video clip would then be accessible immediately and found in the user's video folder and not the user's email inbox. If the video clip is primarily accessible online and the individual does not wish to download the video, the video clip could be added to a browser bookmark or a video list for later viewing.

Embodiments of the present invention may be used to create a list of devices, services or applications, such that when information is received from this list, the information will be automatically translated according to a programmed set of rules. The list preferences, which may be stored in user settings store 120, can be set so that certain parts of the received information can be recognized to create the appropriate translation. For example, text messages via cellular phone, instant messaging or other applications if sent with certain characters or formats that match the predefined criteria would be converted to the appropriate formats, events, or tasks. For example, a user may put the user's cellular telephone on an immediate translation list. The electronic message manager 105 has designated that text messages from the automatic translation list that start with the character string of “task” would automatically be transformed to a task on the user's task list. Furthermore, other character sets could be designated to be recognized to automatically assign priority and due date information.

Thus, electronic message manager 105 is capable of transforming an email with a video attachment into a video with an email attachment. Likewise, by converting audio data to text, a voicemail may be transformed into a calendar event. The electronic message 110 can be easily changed, mixed, matched, and replaced with one or more types of information depending upon the user's settings and according to the user's inputs. The user input may include a gesture, mouse click, drag and drop, or voice command. For example, an email with an attached video may be received by a user, and the user may want to save the video, but does not care about the other information embodied in the email. The user can make a swipe gesture, such as with two fingers to the left, to cause the email to become a video in the videos file folder without any reference to the email. Additionally or alternatively, the email can be made to become a video that retains the email information as either an attachment or as text shown at the end of the video that displays the original email information. Alternatively, if the electronic object 115 is a document, the electronic message 110 may be appended to the end of the electronic object 115. Thus, users will be able to add their own information to the electronic objects 115.

The electronic message 110 is meant to be altered completely as to allow better organization and interaction between other electronic information pieces. For example, electronic mail services and programs receive emails, but do not allow (or make it very difficult for) users to alter the fields or descriptors of that email. Organization of email is difficult and often clumsy, whereas if the user were able to change the subject of the email to the user's own choosing or change the date or title of the email, then the organization becomes much easier. For example, the sender information, subject line, date, attachment information, carbon copy information, and/or blind carbon copy information may be changed to a string, or changed automatically to a user defined string stored in the user settings store 120, of characters and/or symbols for the purpose of organizing the electronic message 110.

In some embodiments, all of the electronic objects in electronic object stores 125, electronic messages 110, and/or electronic objects 115 are accessible within one user interface, such that the email, task lists, contact lists, calendar appointments, calendar events, text, voice recordings, faxes, and social media interactions associated with the electronic objects may be displayed, manipulated, sorted, and organized by the user. For example, a user could attach a social media excerpt or message to a document. As another example, a video could have an attachment of a voicemail. In another example, a user could select a parent electronic object and associate one or more other electronic object(s) to the parent electronic object, such as identifying a contact as a parent electronic object and then associating (e.g., through a drag and drop, gesture, or other predefined or suitable input) a task electronic object, a video electronic object, a social media message, a digital photo, or other child electronic objects wherein the user interface would display a child electronic object when the parent electronic object is selected.

In some embodiments, the electronic message manager 105 may generate and transmit an electronic message that includes an electronic object from electronic object store 125. The electronic message manager 105 may transmit the electronic message using a medium or format that is different than the medium or format used to receive the original electronic message associated with the electronic object. For example, a video received via a social media application may later be sent as an email. Thus, the electronic message manager 105 may receive a first electronic message in a first format and translate the associated electronic object into a second electronic message in a second format.

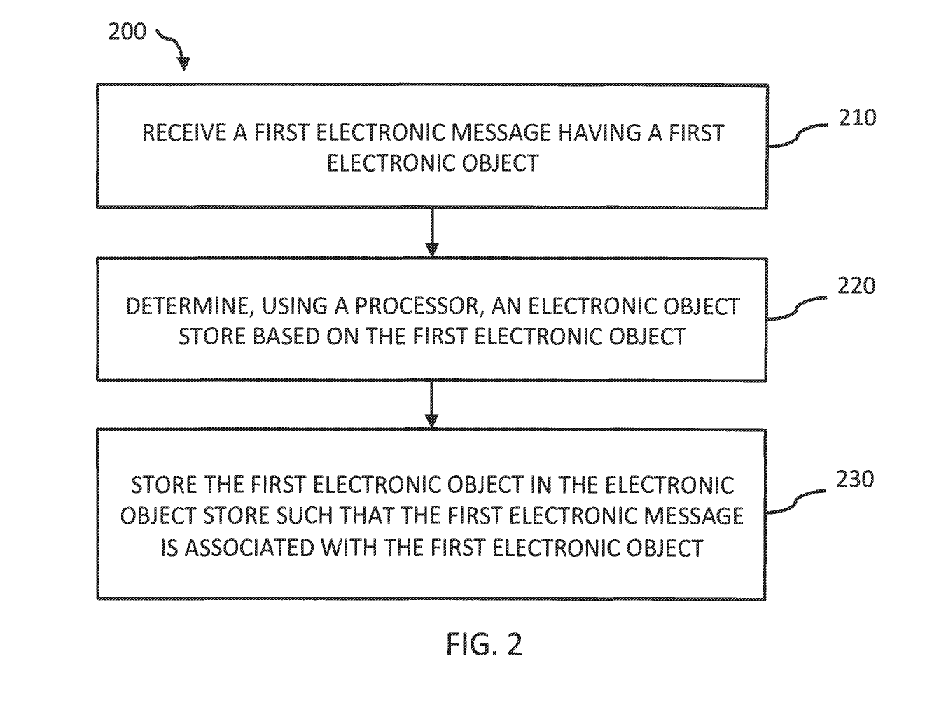

FIG. 2 is a flowchart of an exemplary method 200 for processing electronic messages using system 100 (shown in FIG. 1). In operation 210, a first electronic message is received. The electronic message has at least one electronic object. In operation 220, a processor is used to determine an electronic object store based on the first electronic object. In other words, the processor will determine an electronic object store that is appropriate for the electronic objects. For example, a video directory is appropriate for videos, an address book is appropriate for contacts, a calendar is appropriate for appointments, etc. In operation 230, the one or more electronic objects are stored in the determined electronic object store such that the first electronic message is associated with each of the electronic objects. The first electronic message may be associated with the electronic objects as an attachment, a reference, a link, an addenda, or the like.

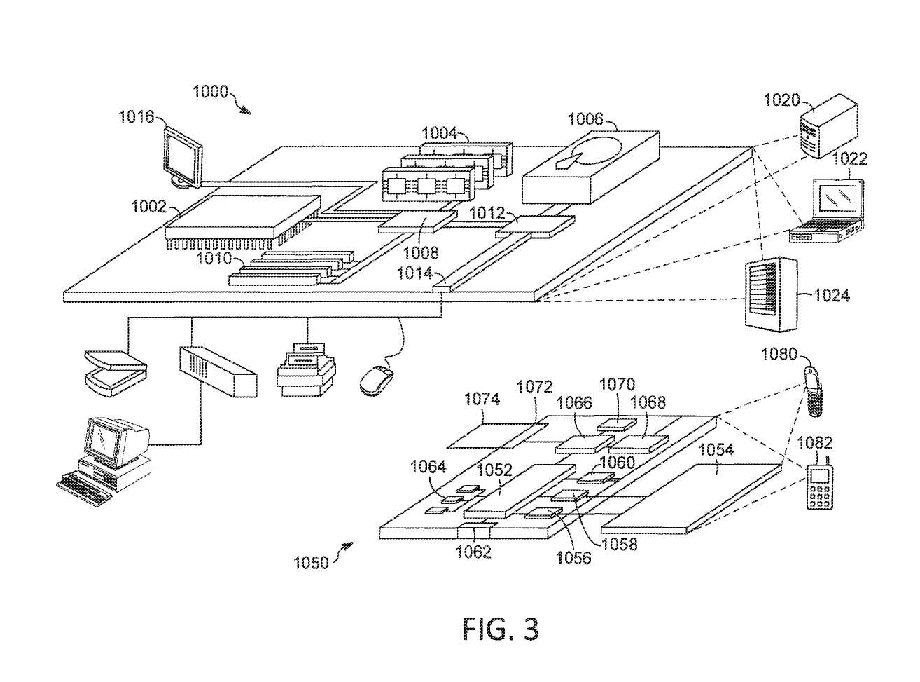

FIG. 3 is a block diagram showing example or representative computing devices and associated elements that may be used to implement the systems of FIG. 1. FIG. 3 shows an example of a generic computing device 1000 and a generic mobile computing device 1050, which may be used with the techniques described here. Computing device 1000 is intended to represent various forms of digital computers, such as laptops, desktops, workstations, personal digital assistants, servers, blade servers, mainframes, and other appropriate computers. Computing device 1050 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 1000 includes a processor 1002, memory 1004, a storage device 1006, a high-speed interface or controller 1008 connecting to memory 1004 and high-speed expansion ports 1010, and a low-speed interface or controller 1012 connecting to low-speed bus 1014 and storage device 1006. Each of the components 1002, 1004, 1006, 1008, 1010, and 1012, are interconnected using various busses, and may be mounted on a common motherboard or in other manners as appropriate. The processor 1002 can process instructions for execution within the computing device 1000, including instructions stored in the memory 1004 or on the storage device 1006 to display graphical information for a GUI on an external input/output device, such as display 1016 coupled to high-speed controller 1008. In other implementations, multiple processors and/or multiple buses may be used, as appropriate, along with multiple memories and types of memory. Also, multiple computing devices 1000 may be connected, with each device providing portions of the necessary operations (e.g., as a server bank, a group of blade servers, or a multi-processor system).

The memory 1004 stores information within the computing device 1000. In one implementation, the memory 1004 is a volatile memory unit or units. In another implementation, the memory 1004 is a non-volatile memory unit or units. The memory 1004 may also be another form of computer-readable medium, such as a magnetic or optical disk.

The storage device 1006 is capable of providing mass storage for the computing device 1000. In one implementation, the storage device 1006 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1004, the storage device 1006, or memory on processor 1002.

The high-speed controller 1008 manages bandwidth-intensive operations for the computing device 1000, while the low-speed controller 1012 manages lower bandwidth-intensive operations. Such allocation of functions is exemplary only. In one implementation, the high-speed controller 1008 is coupled to memory 1004, display 1016 (e.g., through a graphics processor or accelerator), and to high-speed expansion ports 1010, which may accept various expansion cards (not shown). In the implementation, low-speed controller 1012 is coupled to storage device 1006 and low-speed bus 1014. The low-speed bus 1014, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1020, or multiple times in a group of such servers. It may also be implemented as part of a rack server system 1024. In addition, it may be implemented in a personal computer such as a laptop computer 1022. Alternatively, components from computing device 1000 may be combined with other components in a mobile device (not shown), such as device 1050. Each of such devices may contain one or more of computing device 1000, 1050, and an entire system may be made up of multiple computing devices 1000, 1050 communicating with each other.

Computing device 1050 includes a processor 1052, memory 1064, an input/output device such as a display 1054, a communication interface 1066, and a transceiver 1068, among other components. The device 1050 may also be provided with a storage device, such as a microdrive or other device, to provide additional storage. Each of the components 1050, 1052, 1064, 1054, 1066, and 1068, are interconnected using various buses, and several of the components may be mounted on a common motherboard or in other manners as appropriate.

The processor 1052 can execute instructions within the computing device 1050, including instructions stored in the memory 1064. The processor may be implemented as a chipset of chips that include separate and multiple analog and digital processors. The processor may provide, for example, for coordination of the other components of the device 1050, such as control of user interfaces, applications run by device 1050, and wireless communication by device 1050.

Processor 1052 may communicate with a user through control interface 1058 and display interface 1056 coupled to a display 1054. The display 1054 may be, for example, a TFT LCD (Thin-Film-Transistor Liquid Crystal Display) or an OLED (Organic Light Emitting Diode) display, or other appropriate display technology. The display interface 1056 may comprise appropriate circuitry for driving the display 1054 to present graphical and other information to a user. The control interface 1058 may receive commands from a user and convert them for submission to the processor 1052. In addition, an external interface 1062 may be provide in communication with processor 1052, so as to enable near area communication of device 1050 with other devices. External interface 1062 may provide, for example, for wired communication in some implementations, or for wireless communication in other implementations, and multiple interfaces may also be used.

The memory 1064 stores information within the computing device 1050. The memory 1064 can be implemented as one or more of a computer-readable medium or media, a volatile memory unit or units, or a non-volatile memory unit or units. Expansion memory 1074 may also be provided and connected to device 1050 through expansion interface 1072, which may include, for example, a SIMM (Single In Line Memory Module) card interface. Such expansion memory 1074 may provide extra storage space for device 1050, or may also store applications or other information for device 550. Specifically, expansion memory 1074 may include instructions to carry out or supplement the processes described above, and may include secure information also. Thus, for example, expansion memory 1074 may be provide as a security module for device 1050, and may be programmed with instructions that permit secure use of device 1050. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1064, expansion memory 1074, or memory on processor 1052, that may be received, for example, over transceiver 1068 or external interface 1062.

Device 1050 may communicate wirelessly through communication interface 1066, which may include digital signal processing circuitry where necessary. Communication interface 1066 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1068. In addition, short-range communication may occur, such as using a Bluetooth, Wife, or other such transceiver (not shown). In addition, GPS (Global Positioning system) receiver module 1070 may provide additional navigation- and location-related wireless data to device 1050, which may be used as appropriate by applications running on device 1050.

Device 1050 may also communicate audibly using audio codec 1060, which may receive spoken information from a user and convert it to usable digital information. Audio codec 1060 may likewise generate audible sound for a user, such as through a speaker, e.g., in a handset of device 1050. Such sound may include sound from voice telephone calls, may include recorded sound (e.g., voice messages, music files, etc.) and may also include sound generated by applications operating on device 1050.

The computing device 1050 may be implemented in a number of different forms, as shown in the figure. For example, it may be implemented as a cellular telephone 1080. It may also be implemented as part of a smart phone 1082, personal digital assistant, a computer tablet, or other similar mobile device.

Thus, various implementations of the systems and techniques described here can be realized in digital electronic circuitry, integrated circuitry, specially designed ASICs (application specific integrated circuits), computer hardware, firmware, software, and/or combinations thereof These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system (e.g., computing device 1000 and/or 1050) that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In the example embodiment, computing devices 1000 and 1050 are configured to receive and/or retrieve electronic documents from various other computing devices connected to computing devices 1000 and 1050 through a communication network, and store these electronic documents within at least one of memory 1004, storage device 1006, and memory 1064. Computing devices 1000 and 1050 are further configured to manage and organize these electronic documents within at least one of memory 1004, storage device 1006, and memory 1064 using the techniques described herein.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included. Also, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “identifying” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments of the invention may be implemented using computer programming or engineering techniques including computer software, firmware, hardware or any combination or subset thereof Any such resulting program, having computer-readable and/or computer-executable instructions, may be embodied or provided within one or more computer-readable media, thereby making a computer program product, i.e., an article of manufacture, according to the discussed embodiments of the invention. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

The invention, as illustrated herein as various embodiments, is a type of electronic information processing and storage application and/or system that processes the various electronic forms of information. Whether the information is received or sent, the systems and methods described herein will package the information in the most appropriate format or cause it to be converted to the most appropriate format at the point of receiving. It will allow delivery by the most readily available or preferred format and then change or convert or add appropriate formats after delivery or reception.

While the disclosure has been described in terms of various specific embodiments, it will be recognized that the disclosure can be practiced with modification within the spirit and scope of the claims.

What is claimed is:

1. A computer-implemented method for processing electronic messages using a computer device coupled to a memory device, the method comprising:
receiving a first electronic message having a first electronic object;
determining, using a processor, an electronic object store based on the first electronic object; and
storing the first electronic object in the electronic object store such that the first electronic message is associated with the first electronic object.

2. The computer-implemented method of claim 1, wherein receiving a first electronic message comprises receiving the first electronic message into an electronic message inbox.

3. The computer-implemented method of claim 2, further comprising deleting the first electronic message from the electronic message inbox.

4. The computer-implemented method of claim 1, further comprising generating a second electronic object based on the first electronic message.

5. The computer-implemented method of claim 1, further comprising appending the first electronic message to the first electronic object.

6. The computer-implemented method of claim 1, further comprising generating a second electronic message that includes the first electronic object.

7. The computer-implemented method of claim 1, further comprising transforming the first electronic object to a text format, wherein the first electronic object includes audio data.

8. The computer-implemented method of claim 1, further comprising changing a descriptor associated with the first electronic message.

9. The computer-implemented method of claim 8, wherein changing a descriptor comprises changing a subject line based on user input.

10. The computer-implemented method of claim 1, further comprising providing a user interface capable of displaying the electronic message store.

11. The computer-implemented method of claim 10, wherein determining an electronic message store comprises:
receiving user input via the user interface; and
determining an electronic message store based on the user input.

12. A computer program product tangibly embodied in a computer-readable storage device and comprising instructions that, when executed by one or more processors, cause the one or more processors to perform operations comprising:
receiving a first electronic message having a first electronic object;
determining, using a processor, an electronic object store based on the first electronic object; and
storing the first electronic object in the electronic object store such that the first electronic message is associated with the first electronic object.

13. The computer program product of claim 12, wherein receiving a first electronic message comprises receiving the first electronic message into an electronic message inbox.

14. The computer program product of claim 13, wherein the operations further comprise deleting the first electronic message from the electronic message inbox.

15. The computer program product of claim 12, wherein the operations further comprise generating a second electronic object based on the first electronic message.

16. The computer program product of claim 12, wherein the operations further comprise appending the first electronic message to the first electronic object.

17. The computer program product of claim 12, wherein the operations further comprise changing a descriptor associated with the first electronic message.

18. A computer system including instructions stored on a non-transitory computer-readable medium and executable by at least one processor, the computer system comprising:
a plurality of electronic object stores; and
an electronic message manager for:
receiving a first electronic message having a first electronic object;
determining, using a processor, an electronic object store from said plurality of electronic object stores based on the first electronic object; and
storing the first electronic object in the electronic object store such that the first electronic message is associated with the first electronic object.

19. The computer system of claim 18, wherein said electronic message manager is further configured to generate a second electronic object based on the first electronic message.

20. The computer system of claim 18, wherein said electronic message manager is further configured to change a descriptor associated with the first electronic object.
